(19) United States
(12) Patent Application Publication
(10) Pub. No.: US 2013/0029828 A1
(43) Pub. Date: Jan. 31, 2013

(54) SYSTEM COMPRISING CENTRIFUGAL SEPARATOR AND METHOD FOR CONTROLLING SUCH A SYSTEM

(71) Applicants: Carl Häggmark, Taby (SE); Sverker Danielsson, Bromma (SE); Peter Thorwid, Sundbyberg (SE); Roland Isaksson, Grodinge (SE); Hans Moberg, Stockholm (SE); Johan Agrell, Taby (SE); Anders Svensson, Saltsjoboo (SE)

(72) Inventors: Carl Häggmark, Taby (SE); Sverker Danielsson, Bromma (SE); Peter Thorwid, Sundbyberg (SE); Roland Isaksson, Grodinge (SE); Hans Moberg, Stockholm (SE); Johan Agrell, Taby (SE); Anders Svensson, Saltsjoboo (SE)

(73) Assignee: ALFA LAVAL CORPORATE AB, Lund (SE)

(21) Appl. No.: 13/575,366

(22) PCT Filed: Jan. 28, 2011
(86) PCT No.: PCT/SE11/50091

§ 371 Date: Sep. 28, 2012

(30) Foreign Application Priority Data
Jan. 29, 2010 (SE) 1000085-9

(51) Int. Cl. B04B 13/00; B04B 11/04

(52) U.S. Cl. 494/2; 494/37

(57) ABSTRACT

The present invention relates to a system comprising a hermetic centrifugal separator where the separator comprises a rotor including a separation chamber, an inlet channel for a mixture of components to be separated, a first outlet channel for receiving at least one separated light component, and a second outlet channel for receiving at least one separated heavy component.

### FIELD

The present invention relates to a system having a centrifugal separator.

### SUMMARY OF THE INVENTION

The present invention relates to a system comprising a hermetic centrifugal separator, where the separator comprises a rotor including a separation chamber, an inlet channel for a mixture of components to be separated, a first outlet channel for receiving at least one separated light component, a second outlet channel for receiving at least one separated heavy component, the system further comprising recirculation means for recirculating from said second outlet channel to said separation chamber part of the separated heavy component.

According to a second aspect, the present invention relates to a method of controlling such a system comprising the following steps: feeding a mixture of components into a separation chamber from an inlet channel; separating said mixture of components in said separation chamber into light and heavy components; leading at least one light component into a first outlet; leading at least one heavy component into a second outlet; recirculating part of the separated heavy component from said second outlet into said inlet channel;

Such systems are used when the content of the heavy component in a mixture varies heavily or is constantly low, whereas it is often desired to obtain a separated sludge with a constant concentration, to e.g. avoid clogging in heavy phase outlet pipes.

It is an object of the present invention to provide an improved system comprising a hermetical centrifugal separator and a method of controlling such a system with which it is possible to control the heavy phase flow rate.

In accordance with the invention there is therefore provided a system comprising centrifugal separator as initially described hereinabove, wherein a first monitoring means is monitoring density, flow rate, or combination thereof, of the heavy component flowing in said second outlet channel, and a first control means is controlling recirculation flow in response to a control signal from said first monitoring means.

In a preferred embodiment of the present invention the system comprises a second monitoring means monitoring flow rate of the heavy component flowing in said second outlet channel, and a second control means controlling the pressure by controlling a first back pressure valve in said first outlet channel in response to a control signal from said second monitoring means.

In a further preferred embodiment of the present invention the system comprises a third monitoring means monitoring pressure in said second outlet channel, and a third control means controlling the pressure by controlling a second back pressure valve in said second outlet channel in response to a control signal from said third monitoring means.

In yet another preferred embodiment of the present invention the system said control means are controlling in response to a signal based on a difference between a control signal from said monitoring means and a desired set point for a monitored parameter.

In another preferred embodiment of the present invention the system comprises a fourth monitoring means monitoring flow rate in said recirculation means, and a fourth control means controlling recirculation flow rate in response to a control signal from said fourth monitoring means, where said fourth control means is getting its set point from the output of said first control means.

According to an embodiment of the present invention said control means are PID controllers.

In another embodiment of the present invention said first control means is a MPC controller and said second, third and fourth control means are PID controllers, and where said first control means are supplying set points to at least one of said second, third and fourth control means.

In a further embodiment of the present invention said second outlet channel is connected to heavy component outlet pipes inside the separation chamber where said pipes have inlet openings close to the interior wall of the separator bowl.

In accordance with the second aspect of the invention there is provided a method as initially described hereinabove, wherein it further comprises the following steps: monitoring parameters of density, flow rate or combination thereof, of the heavy component flowing in said second outlet channel; creating a control signal in relation to said parameter(s); and controlling the recirculation flow in response to said control signal.

According to an embodiment of this second aspect of the present invention the method comprises the following steps: monitoring a parameter of flow rate, of the heavy component flowing in said second outlet channel; creating a second control signal in relation to said parameter of flow rate; and controlling the pressure in said first outlet channel by controlling a first back pressure valve in said first outlet channel in response to said second control signal.

In a further embodiment of this aspect of the present invention the method comprises the following steps: monitoring a parameter of pressure in said second outlet channel; creating a third control signal in relation to said parameter of pressure; and controlling the pressure in said second outlet channel by controlling a second back pressure valve in said second outlet channel in response to said third control signal.

In another embodiment of this aspect of the present invention the method said step of controlling comprises, computing of a difference between said control signal and a desired set point for a monitored parameter.

In a further embodiment of this aspect of the present invention the method comprises the steps of: monitoring a parameter of flow rate in said recirculation means; creating a fourth control signal in relation to said parameter of flow rate in said recirculation means; and controlling said recirculation flow rate in response to said fourth control signal, where said controlling is comprising computing of a difference between said fourth control signal and a set point which corresponds to the first control signal.

The invention thus provides a system and method which control the characteristics of the separated heavy component even when feeding the separator with a feed of varying contents.

The system and the method according to the invention are described below in a more detailed description of preferred embodiments of the present invention referring to the drawings FIGS. 1-4.

### BRIEF DESCRIPTION OF THE DRAWINGS

FIG. 1 is a flow chart of one embodiment of the system according to the present invention.

FIG. 2 is a flow chart of a second embodiment of the system according to the present invention.

FIG. 3 is a flow chart of a third embodiment of the system according to the present invention.

FIG. 4 is a sectioned side view of the upper part of a separator bowl according to an embodiment of the invention.

### DETAILED DESCRIPTION

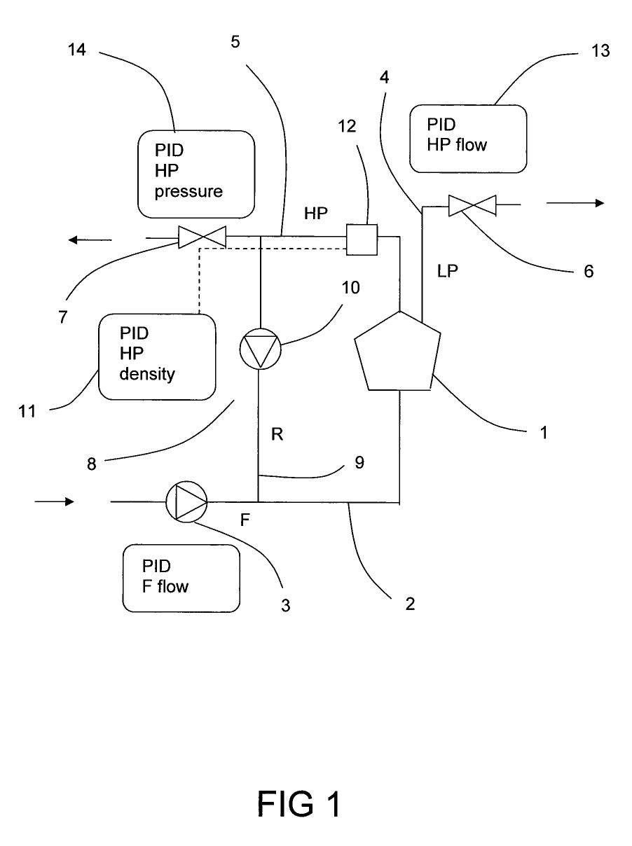

In FIG. 1 a centrifugal system disclosed, comprising a hermetic centrifugal separator 1, which is fed with a mixture of components to be separated through an inlet channel 2 by feeding pump 3. In said separator 1 a liquid mixture of components centrifuged in a rotor with a separation chamber in which the components are separated. There is a first outlet channel 4 connected to the separation chamber for receiving at least one separated light component, and a second outlet channel 5 for receiving at least one separated heavy component.

In each outlet channel 4, 5 is a (first and second resp.) back pressure valve 6, 7 arranged. Leading from said second outlet channel 5 for heavy components to said inlet channel 2 is a recirculation means 8 arranged. Said recirculation means 8 comprises a recirculation channel 9 adapted to deviate part of the separated heavy component upstreams of said second back pressure valve 7 and a recirculation pump 10 adapted to pump said part of the separated heavy component to said inlet channel 2.

The pumping flow of the recirculation pump 10 is controlled by a so called PID controller (Proportional-Integral-Derivative) 11 which responds continually or intermittently to a signal from a coriolis flow meter 12 located in said outlet channel 5 for heavy components. Said signal derives from a calculated difference between a measured flow or density and a desired set point. It is for instance highly desirable that the outlet channel 5 is not subject to clogging as the continuous flow of heavy component is then interrupted. The desired set point may then be of a value that ascertains a continuing flow.

Also the back pressure valves 6, 7 are provided with PID controllers 13, 14.

The PID controller 13 controlling the back pressure valve 6 in the light component outlet channel 4 responds to a signal based on a difference between the heavy component flow in the outlet channel 5 and a desired set point of the same. The PID controller 11 is then responding to the density of the heavy component in the outlet channel 5.

The PID controller 14 controlling the back pressure valve 7 in the heavy component outlet channel 5 is responding to the back pressure in said heavy component outlet channel 5.

The idea is to control the recirculation flow to control the density while the light component valve 6 controls the heavy component pressure.

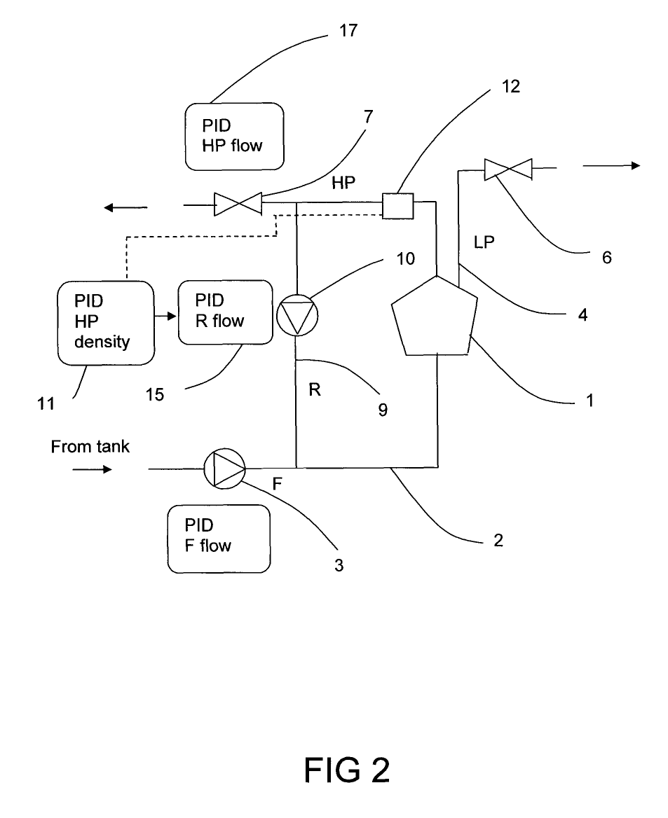

This control strategy can be modified by adding a so called cascaded controller over the recirculation pump 10, as can be seen in FIG. 2. In cascade control there are two PIDs arranged with one PID controlling the set point of another. A PID controller acts as outer loop controller, which controls the primary physical parameter, such as fluid level or velocity. The other controller acts as inner loop controller, which reads the output of outer loop controller as set point, usually controlling a more rapid changing parameter, flow rate or acceleration.

In FIG. 2 a PID controller 15 is arranged in an inner loop controlling the recirculation flow in response to a signal based on the recirculation flow after said pump 10, and in an outer loop a PID controller 16, getting its control signal from the monitored density in the heavy component output channel, provides PID controller 15 with a set point.

The idea with cascaded controllers is that the inner loop is much faster than the outer loop. The outer controller thus considers the control signal (i.e. the set point to the inner loop) as being realized immediately because of the different time scales they operate in. The control is still decentralized, but now there is also the possibility of controlling the recirculation flow by setting its set point. A PID controller 17 controlling the heavy component back pressure valve 7 responds to a signal calculated from the heavy component flow monitored by the coriolis flow meter.

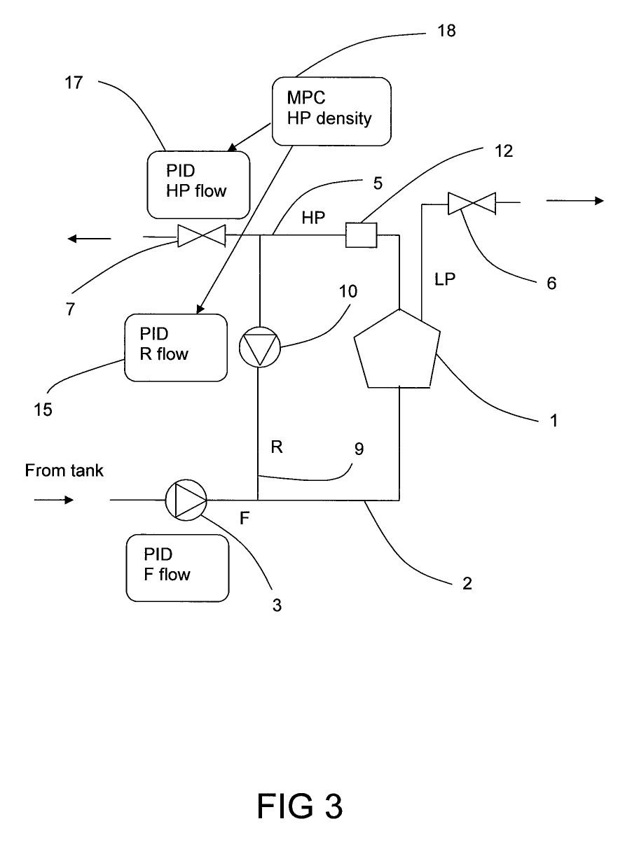

In FIG. 3 is an embodiment of the system where a so called MPC controller 18 (Model Predictive Controller) is applied to manipulate the control signals directly and according a desired operation course. For example, when separating a mixture that varies in heavy component concentration during operation it is often preferred that the parameters controlled by the PID-controllers are regulated according to graphs that optimize the process in reference to e.g. efficiency, quality of the output and/or clogging risk. The MPC controller 18 is then controlling the reference values of the underlying controllers, i.e. the PID-controllers, meaning that the manipulated variables of the MPC controller are the set points for the PID-controllers (e.g. flow rate, density or pressure). This makes the whole control into a cascaded controller where the MPC controller is the outer loop for all the PID-controllers. The PID-controllers are configured as in FIG. 2 with the exception that the PID controller controlling the density in the heavy component outlet channel is deactivated. In this embodiment the MPC controller controls the density by setting reference values for the recirculation flow and the heavy component flow while the feed flow set point is held constant.

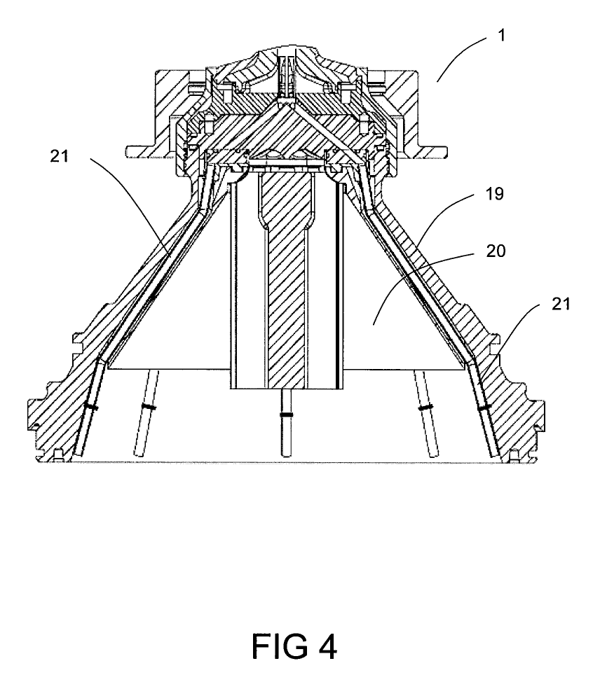

FIG. 4 discloses an upper part of a separator bowl 19 which separator bowl defines a separation chamber 20. The heavy components of the separated mixture will, due to the centrifugal forces, collect in the area most remote from the rotational axis i.e. close to the interior wall of the separator bowl. In conventional centrifugal separators the heavy components are discharged through ports in the periphery of the separator bowl 19 at certain intervals to prevent build up inside the separator. However, in the centrifugal separator according to the present invention, the heavy components are fed continuously from the separation chamber 20 out through a heavy component outlet channel 5 arranged on top of the separator bowl 19. The inside of the of the separator bowl 19 is therefore provided with heavy component outlet pipes 21 arranged on, in or close to the interior wall of said upper part of the separator bowl 19. The outlet pipes 21 follow the interior wall and extend upwards towards and connect to the heavy component outlet channel 5 and are thus leading the heavy components from the peripheral part of the separation chamber 20 radially inwards and upwards to said heavy component outlet channel 5. By choosing length of the heavy component pipes 21 and position for their inlet orifices in the separation chamber 20 it is possible to control the characteristics of the sludge fed to the pipes 21.

An application of the present invention discloses a system according to the present invention where the hermetic centrifugal separator is equipped with conventional ejection openings for optional intermittent discharge of sludge.

To a person skilled in the art the present invention is not limited by the described examples and several modifications and alternatives are possible within the scope of the present invention as defined by the claims.

What is claimed is:

1-14. (canceled)

15. A system comprising
a hermetic centrifugal separator,
where the separator comprises:
a rotor including a separation chamber,
an inlet channel for a mixture of components to be separated,
a first outlet channel for receiving at least one separated light component,
a second outlet channel for receiving at least one separated heavy component,
the system further comprising recirculation means for recirculating from said second outlet channel to said separation chamber part of the separated heavy component,
a first monitoring means monitoring density, flow rate, or combination thereof, of the heavy component flowing in said second outlet channel,
a first control means controlling recirculation flow rate in response to a control signal from said first monitoring means.

16. A system according to claim 15, comprising:
a second monitoring means monitoring flow rate of the heavy component flowing in said second outlet channel,
a second control means controlling the pressure by controlling a first back pressure valve in said first outlet channel in response to a control signal from said second monitoring means.

17. A system according to claim 15, comprising:
a third monitoring means monitoring pressure in said second outlet channel,
a third control means controlling the pressure by controlling a second back pressure valve in said second outlet channel in response to a control signal from said third monitoring means.

18. A system according to claim 15, wherein said control means are controlling in response to a signal based on a difference between a control signal from said monitoring means and a desired set point for a monitored parameter.

19. A system according to claim 15, comprising:
a fourth monitoring means monitoring flow rate in said recirculation means,
a fourth control means controlling recirculation flow rate in response to a control signal from said fourth monitoring means, where said fourth control means is getting its set point from the output of said first control means.

20. A system according to claim 15, wherein said control means are PID controllers.

21. A system according to claim 15, wherein said first control means is a MPC controller and a second, third and fourth control means are PID controllers, and where said first control means are supplying set points to at least one of said second, third and fourth control means.

22. A system according to claim 15, wherein said second outlet channel is connected to heavy component outlet pipes inside the separation chamber where said pipes have inlet openings close to an interior wall of a separator bowl.

23. A system according to claim 15, wherein the hermetic centrifugal separator is equipped with ejection openings for optional intermittent discharge of sludge.

24. A method of controlling a system according to claim 15, the method comprising the following steps:
feeding a mixture of components into a separation chamber from an inlet channel;
separating said mixture of components in said separation chamber into light and heavy components;
leading at least one light component into a first outlet channel;
leading at least one heavy component into a second outlet channel;
recirculating part of the separated heavy component from said second outlet channel into said inlet channel;
monitoring parameters of density, flow rate or combination thereof, of the heavy component flowing in said second outlet channel;
creating a first control signal in relation to said parameter(s);
and controlling the recirculation flow rate in response to said control signal.

25. A method according to claim 24 comprising the following steps:
monitoring a parameter of flow rate, of the heavy component flowing in said second outlet channel;
creating a second control signal in relation to said parameter of flow rate;
and controlling pressure in said first outlet channel by controlling a first back pressure valve in said first outlet channel in response to said second control signal.

26. A method according to claim 24, comprising the following steps:
monitoring a parameter of pressure in said second outlet channel;
creating a third control signal in relation to said parameter of pressure;
and controlling pressure in said second outlet channel by controlling a second back pressure valve in said second outlet channel in response to said third control signal.

27. A method according to claim 24, wherein the step of controlling comprises:
computing of a difference between said control signal and a desired set point for a monitored parameter.

28. A method according to claim 27, comprising:
monitoring a parameter of flow rate in said recirculation means;
creating a fourth control signal in relation to said parameter of flow rate in said recirculation means;
and controlling recirculation flow rate in response to said fourth control signal, where said controlling comprises computing a difference between said fourth control signal and a set point which corresponds to the first control signal.
